(19) United States
(12) Patent Application Publication
(10) Pub. No.: US 2022/0055400 A1
(43) Pub. Date: Feb. 24, 2022

(54) Covered Paint Tray Assembly

(71) Applicant: Edward Eldridge, Marathon, FL (US)

(72) Inventor: Edward Eldridge, Marathon, FL (US)

(21) Appl. No.: 16/997,452

(22) Filed: Aug. 19, 2020

(51) Int. Cl. B44D 3/12

(52) U.S. Cl. CPC B44D 3/126; B44D 3/127

(57) ABSTRACT

A covered paint tray assembly for storing paint and a paint roller includes a pan that has a sloped floor for containing a fluid paint. The pan has a first groove therein to accommodate a rod of a paint roller. A lid is provided and the lid can be positioned on the pan. The lid releasably engages the pan when the lid is positioned thereon to inhibit the fluid paint from spilling out of the pan. The lid has a second groove therein to accommodate the rod of the paint roller.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to paint tray devices and more particularly pertains to a new paint tray device for storing paint and a paint roller.

### (2) Description of Related Art Including Information Disclosed Under 37 CFR 1.97 and 1.98

The prior art relates to paint tray devices including a pair of paint trays that are attachable together to form an enclosure for storing paint. The prior art discloses a variety of paint trays that include lids that form a fluid impermeable seal for storing fluid paint. The prior art disclose a paint tray that includes a hinged lid and a groove for accommodating a handle of a paint roller when the hinged lid is closed. The prior art discloses a modular paint tray system for storing fluid paint without drying. The prior art discloses a paint tray lid that has formed features for accommodating a paint roller. The prior art discloses a paint tray that has a groove therein for accommodating a handle of a paint roller.

### BRIEF SUMMARY OF THE INVENTION

An embodiment of the disclosure meets the needs presented above by generally comprising a pan that has a sloped floor for containing a fluid paint. The pan has a first groove therein to accommodate a rod of a paint roller. A lid is provided and the lid can be positioned on the pan. The lid releasably engages the pan when the lid is positioned thereon to inhibit the fluid paint from spilling out of the pan. The lid has a second groove therein to accommodate the rod of the paint roller.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an exploded perspective view of a covered paint tray assembly according to an embodiment of the disclosure.

FIG. 2 is a top perspective view of an embodiment of the disclosure.

FIG. 3 is a front view of an embodiment of the disclosure.

FIG. 4 is a back view of an embodiment of the disclosure.

FIG. 5 is a right side phantom view of an embodiment of the disclosure.

### DETAILED DESCRIPTION OF THE INVENTION

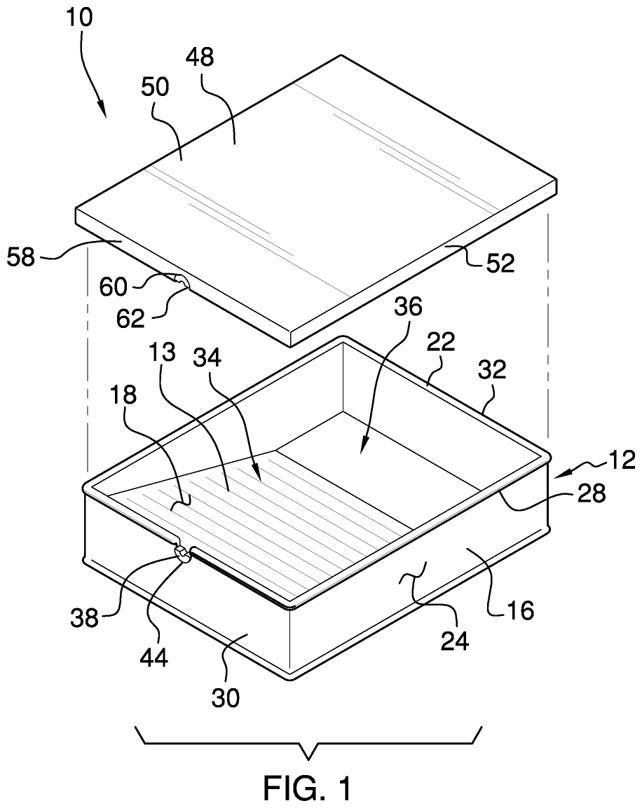

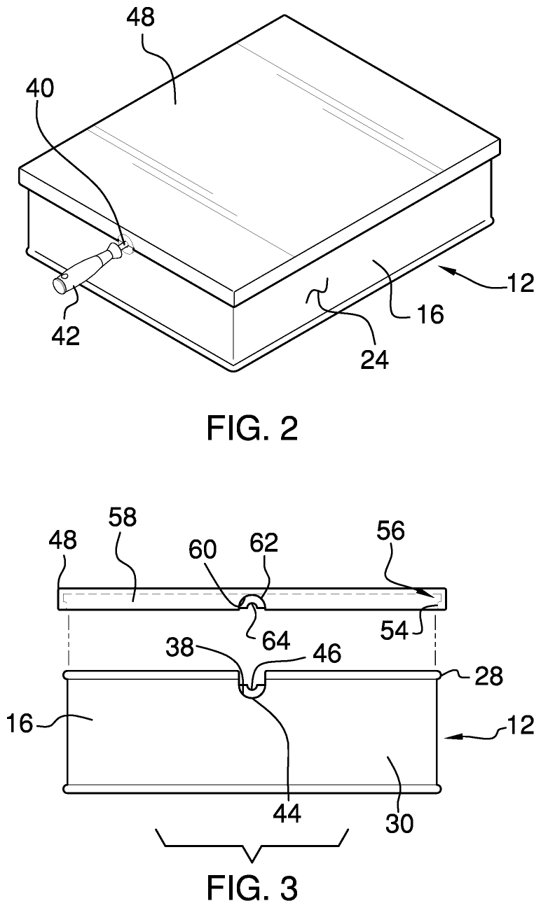

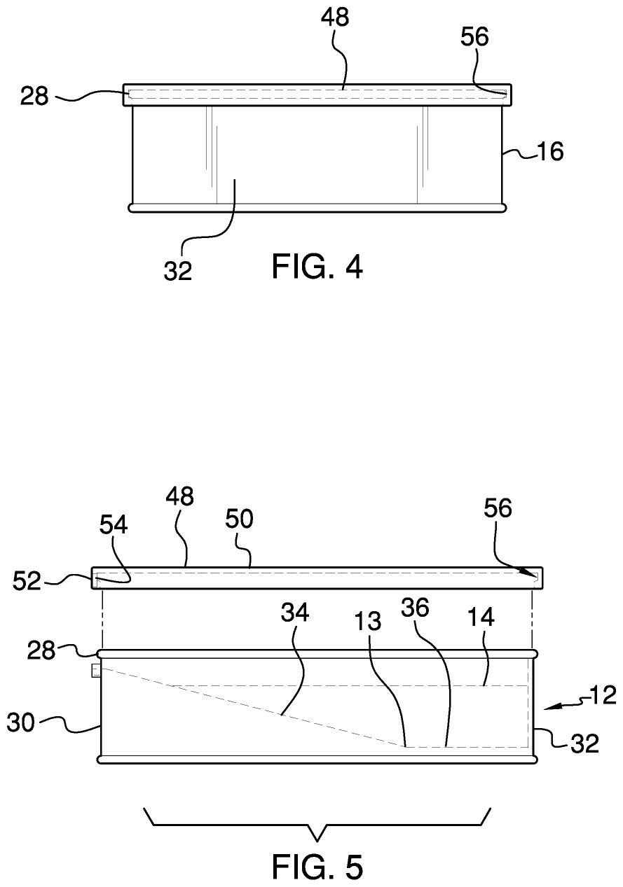

With reference now to the drawings, and in particular to FIGS. 1 through 5 thereof, a new paint tray device embodying the principles and concepts of an embodiment of the disclosure and generally designated by the reference numeral 10 will be described.

As best illustrated in FIGS. 1 through 5, the covered paint tray assembly 10 generally comprises a pan 12 that has a sloped floor 13 to facilitate the pan 12 to contain a fluid paint 14. The pan 12 has a perimeter wall 16 extending upwardly from a top surface 18 of the sloped floor 13. The perimeter wall 16 has a distal edge 22 with respect to the sloped floor 13 and an outer surface 24. The perimeter wall 16 has a lip 28 extending outwardly from the outer surface 24 and the lip 28 is aligned with the distal edge 22. Moreover, the lip 28 extends around a full perimeter of the perimeter wall 16.

The perimeter wall 16 has a front side 30 and a back side 32, and the sloped floor 13 has a sloped portion 34 forming an angle with a flat portion 36. The sloped portion 34 slopes downwardly between the front side 30 of the perimeter wall 16 and the flat portion 36. Additionally, the flat portion 36 extends between the back side 32 of the perimeter wall 16 and the sloped portion 34. The front side 30 of the perimeter wall 16 has a first groove 38 extending downwardly from the distal edge 22 to receive a rod 40 of a paint roller 42. A first gasket 44 is positioned in the first groove 38 and the first gasket 44 has a concavely arcuate surface 46 to conform to the curvature of the rod 40 of the paint roller 42. Additionally, the first gasket 44 is comprised of a resiliently deformable material to form a fluid impermeable seal with the rod 40.

A lid 48 is provided and the lid 48 is positionable on the pan 12. The lid 48 releasably engages the pan 12 when the lid 48 is positioned thereon to inhibit the fluid paint 14 from spilling out of the pan 12. The lid 48 has a top wall 50 and an outer wall 52 extending downwardly therefrom, and the outer wall 52 has an inwardly facing surface 54. The inwardly facing surface 54 has a channel 56 extending therein and the channel 56 extends around an entire perimeter of the outer wall 52. Moreover, the channel 56 engages the lip 28 on the perimeter wall 16 of the pan 12 when the lid 48 is positioned on the pan 12. In this way the lid 48 forms a fluid impermeable seal with the pan 12 to inhibit the fluid paint 14 from spilling.

The outer wall 52 has a rear side 58 and the rear side 58 has a second groove 60 therein to accommodate the rod 40 of the paint roller 42. The second groove 60 is aligned with the first groove 38 when the lid 48 is positioned on the pan 12. A second gasket 62 is positioned in the second groove 60 and the second gasket 62 has a concavely arcuate surface 64 to conform to the curvature of the rod 40 of the paint roller 42. The second gasket 62 is comprised of a resiliently deformable material to form a fluid impermeable seal with the rod 40.

In use, the fluid paint 14 is poured into the pan 12 and the paint roller 42 is dipped into the fluid paint 14. The lid 48 can be placed on the pan 12 while the paint roller 42 is in the pan 12. In this way the paint roller 42 can be stored in the pan 12 without drying out. Thus, the paint roller 42 does not have to be immediately cleaned in order to facilitate the paint roller 42 to be used at a later time. In this way a painter can employ the pan 12 and the paint roller 42 for several consecutive days without the need to clean or replace the paint roller 42. Additionally, the lid 48 inhibits the fluid paint 14 from being spilled out of the pan 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A covered paint tray assembly for containing paint and a paint roller, said assembly comprising:
a pan having a sloped floor wherein said pan is configured to contain a fluid paint, said pan having a first groove therein wherein said first groove is configured to accommodate a rod of a paint roller; and
a lid being positionable on said pan, said lid releasably engaging said pan when said lid is positioned thereon wherein said lid is configured to inhibit the fluid paint from spilling out of said pan, said lid having a second groove therein wherein said second groove is configured to accommodate the rod of the paint roller.

2. The assembly according to claim 1, wherein said pan has a perimeter wall extending upwardly from a top surface of said sloped floor, said perimeter wall having a distal edge with respect to said sloped floor and an outer surface, said perimeter wall having a lip extending outwardly from said outer surface, said lip being aligned with said distal edge, said lip extending around a full perimeter of said perimeter wall, said perimeter wall having a front side and a back side.

3. The assembly according to claim 2, wherein said sloped floor has a sloped portion forming an angle with a flat portion, said sloped portion sloping downwardly between said front side of said perimeter wall and said flat portion, said flat portion extending between said back side of said perimeter wall and said sloped portion.

4. The assembly according to claim 2, wherein said first groove extends downwardly from said distal edge of said front side of said perimeter wall wherein said first groove is configured to receive a rod of a paint roller.

5. The assembly according to claim 4, further comprising a first gasket being positioned in said first groove, said first gasket having a concavely arcuate surface wherein said concavely arcuate surface is configured to conform to the curvature of the rod of the paint roller, said first gasket being comprised of a resiliently deformable material wherein said first gasket is configured to form a fluid impermeable seal with the rod.

6. The assembly according to claim 2, wherein said lid has a top wall and an outer wall extending downwardly therefrom, said outer wall having an inwardly facing surface, said inwardly facing surface having a channel extending therein, said channel extending around an entire perimeter of said outer wall, said channel engaging said lip on said perimeter wall of said pan when said lid is positioned on said pan wherein said lid is configured to form a fluid impermeable seal with said pan to inhibit the fluid paint from spilling.

7. The assembly according to claim 5, wherein said outer wall has a rear side, said second groove extending into said rear side wherein said second groove is configured to accommodate the rod of the paint roller, said second groove being aligned with said first groove when said lid is positioned on said pan.

7. The assembly according to claim 6, further comprising a second gasket being positioned in said second groove, said second gasket having a concavely arcuate surface wherein said concavely arcuate surface of said second gasket is configured to conform to the curvature of the rod of the paint roller, said second gasket being comprised of a resiliently deformable material wherein said second gasket is configured to form a fluid impermeable seal with the rod.

8. A covered paint tray assembly for containing paint and a paint roller, said assembly comprising:
a pan having a sloped floor wherein said pan is configured to contain a fluid paint, said pan having a perimeter wall extending upwardly from a top surface of said sloped floor, said perimeter wall having a distal edge with respect to said sloped floor and an outer surface, said perimeter wall having a lip extending outwardly from said outer surface, said lip being aligned with said distal edge, said lip extending around a full perimeter of said perimeter wall, said perimeter wall having a front side and a back side, said sloped floor having a sloped portion forming an angle with a flat portion, said sloped portion sloping downwardly between said front side of said perimeter wall and said flat portion, said flat portion extending between said back side of said perimeter wall and said sloped portion, said front side of said perimeter wall having a first groove extending downwardly from said distal edge wherein said first groove is configured to receive a rod of a paint roller;
a first gasket being positioned in said first groove, said first gasket having a concavely arcuate surface wherein said concavely arcuate surface is configured to conform to the curvature of the rod of the paint roller, said first gasket being comprised of a resiliently deformable material wherein said first gasket is configured to form a fluid impermeable seal with the rod;
a lid being positionable on said pan, said lid releasably engaging said pan when said lid is positioned thereon wherein said lid is configured to inhibit the fluid paint from spilling out of said pan, said lid having a top wall and an outer wall extending downwardly therefrom, said outer wall having an inwardly facing surface, said inwardly facing surface having a channel extending therein, said channel extending around an entire perimeter of said outer wall, said channel engaging said lip on said perimeter wall of said pan when said lid is positioned on said pan wherein said lid is configured to form a fluid impermeable seal with said pan to inhibit the fluid paint from spilling, said outer wall having a rear side, said rear side having a second groove therein wherein said second groove is configured to accommodate the rod of the paint roller, said second groove being aligned with said first groove when said lid is positioned on said pan; and
a second gasket being positioned in said second groove, said second gasket having a concavely arcuate surface wherein said concavely arcuate surface of said second gasket is configured to conform to the curvature of the rod of the paint roller, said second gasket being comprised of a resiliently deformable material wherein said second gasket is configured to form a fluid impermeable seal with the rod.
